(19) United States
(12) Patent Application Publication
(10) Pub. No.: US 2005/0194578 A1
(43) Pub. Date: Sep. 8, 2005

(54) Innerduct guide tube assembly for fiber optic cable

(76) Inventor: David Drew Morris, Newnan, GA (US)

Correspondence Address: Thomas L. Moses;Legal Department, M-495, PO Box 1926, Spartanburg, SC, 29304, US

(21) Appl. No.: 10/792,363

(22) Filed: Mar. 3, 2004

(51) Int. Cl. H01R 13/60

(52) U.S. Cl. 254/134.3 FT

(57) ABSTRACT

A flexible innerduct guide tube assembly configured to contain a cable within a conduit is provided. The innerduct assembly includes a plurality of guide tubes, each tube configured to contain at least one cable, wherein the tubes are disposed and bundled within a protective textile sleeve. Each guide tube may contain means for pulling a cable into the tube, and such pulling means may include pull cord or tape, or any other means suitable for installing a cable into the guide tube. Other principal features of the invention relate to the material of which the innerduct guide tube assembly is formed, as well as methods for manufacturing and using the innerduct assembly.

### BACKGROUND OF THE INVENTION

The present invention generally relates to tubular conduit of the type that might be employed for the housing of cables, either underground or within buildings, such as fiber optic cable, coaxial cable, or the like. More particularly, the present invention relates to a partitioning device, which may be inserted into such a conduit such that the conduit is divided into separate areas. Specifically, the present invention is directed toward an elongated partitioning device which is flexible, such that it may be inserted into a conduit which is already in place, which may already have at least one cable positioned therein, and which may have turns, bends, or the like therein.

Cable, such as fiber optic communication cable, is often provided underground in great lengths, and may even extend for many miles. It is known in the art to bury the cable in the ground so that the area above ground is not cluttered with the cable and its respective support apparatus. Furthermore, by positioning the cable underground, it is more protected from the weather and other potentially damaging circumstances.

Cable is also installed within building or premise, networks. Such cables are available in a wide variety of configurations, from high tensile strength multi-fiber cables to very low tensile strength single fiber cables. There are two primary methods for the installation of communication cables. First, the cable may be pulled into the conduit using a pull cord, tape or rope, or secondly, the cable may be blown into the conduit using pneumatic force such as compressed air. Pull cords typically have a breaking strength between 400 and 6,000 pounds, and are typically woven or braided. It is important to minimize the force applied to a communication cable during installation due to the fragile nature of the glass.

It is also known in the cable art to position the cable within a conduit in order to more fully protect the cable in the ground or in a building. The conduit is often formed from lengths of polyvinyl chloride tubing or the like, which is laid in the ground or installed within the structure of a building. A rope is then blown through the conduit, and the rope in turn is attached to one of the communication cables. By pulling the rope, the cable is drawn through the conduit. Once in place within the conduit, the cable is protected from damage that may be caused by weather, water and the like.

It has been found that certain rodents will sometimes gnaw through an underground conduit. Hence, much underground conduit is employed which has a diameter of two inches or more, which is large enough to impede damage from most rodents. While such conduit provides excellent protection for communication cable, there is also much unused or “dead” space within such a conduit. With the advent of fiber optic cables, which may be only a half-inch or less in diameter, there is even more dead space within an average conduit.

When a conduit is in place, either underground or in a building, it may be subsequently desired to run a second communications cable at the same location. As such, it would be desirable from a cost and time standpoint to make use of the dead space within an existing conduit, rather than install a new length of conduit. However, it has been found that it is difficult to merely insert a second cable into a conduit that already contains a first cable. When a rope is blown into a conduit already containing a cable, or a second cable is “snaked” through the conduit, they are often impeded by the first cable, making it impossible to insert the second cable.

It has been suggested to provide a divide to be inserted into a conduit in order to separate the conduit into discrete sections, thus making insertion of the second cable easier. A problem has been encountered in that when conduit is placed over long distances or within buildings, corners, curves and undulations will invariably occur therein.

A need exists therefore for a device to separate or partition a conduit into discrete sections. The device must be capable of being inserted into a conduit that is already in place, which may have sharp turns therein. A need also exists for a partitioning device that will provide for improved use of the space within a conduit. It would be desirable to provide an innerduct assembly that could be installed one time, and which would allow cables to be pulled therein at a later date, as desired, with minimal cost and effort. It would also be desirable to provide individual guide tubes to protect the cable housed therein, and to provide a predetermined open pathway for future cables to be installed. Further, a need exists for a partitioning device that may be used within buildings, and which would meet necessary building code requirements for fire resistance, while facilitating cable placement and maintaining installation performance.

### SUMMARY OF THE INVENTION

The present invention comprises a flexible innerduct guide tube assembly configured to contain a cable within a conduit. The innerduct assembly includes a plurality of guide tubes, each tube configured to contain at least one cable, wherein the tubes are disposed and bundled within a protective textile sleeve. Each guide tube may contain means for pulling a cable into the tube, and such pulling means may include pull cord or tape, or any other means suitable for installing a cable into the guide tube. Other principal features of the invention relate to the material of which the innerduct guide tube assembly is formed, as well as methods for manufacturing and using the innerduct assembly.

### BRIEF DESCRIPTION OF THE DRAWINGS

The invention shall become apparent from the description that follows, in view of the drawings in which:

FIG. 1 is a perspective view of one embodiment of an innerduct guide tube assembly within a conduit;

FIG. 2 is a cross-sectional view of one embodiment of an innerduct guide tube assembly within a conduit; and

FIG. 3 is a cut-away side view of one embodiment of an innerduct guide tube assembly being pulled into a conduit.

### DESCRIPTION

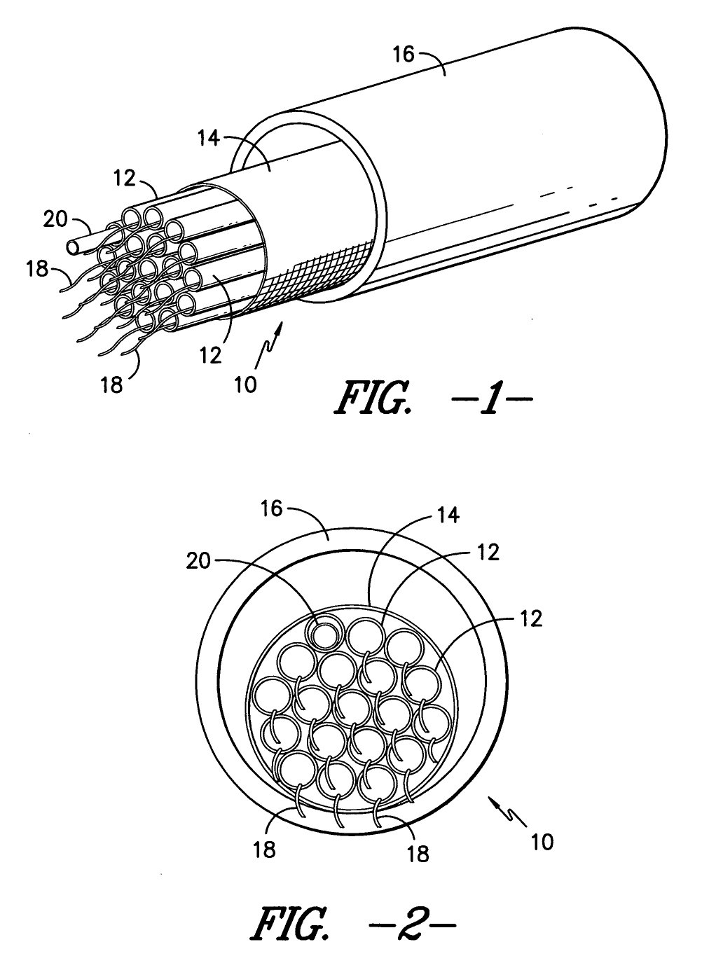

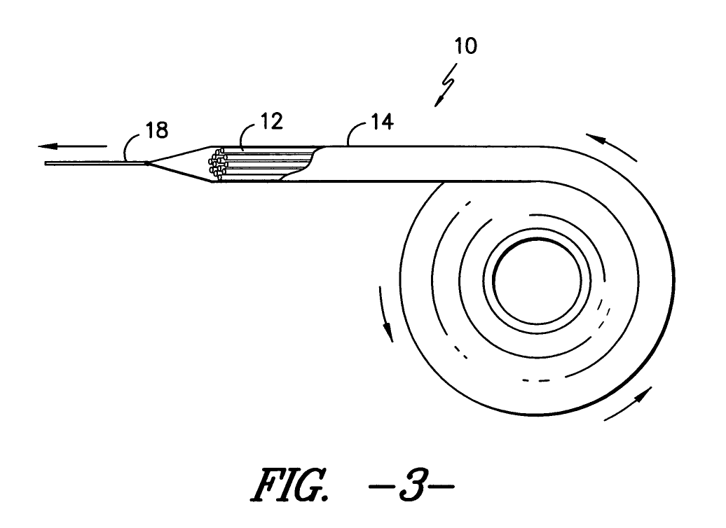

Referring now to the drawings, FIGS. 1 and 2 show an innerduct guide tube assembly 10 comprising a plurality of guide tubes 12 bundled within a textile sleeve 14. The innerduct structure 10 is disposed within a pipe or conduit 16 and each guide tube 12 includes a pull cord 18 or other pull means for pulling a cable into the guide tube. In an alternative embodiment, the cable may be blown into the guide tube using pneumatic pressure, thereby obviating the need for a pull cord. Each guide tube provides a dedicated pathway for a cable 20.

In a preferred embodiment, the guide tubes 12 are used in conjunction with the installation of small diameter cables, generally less than 15 millimeter cables, having tensile strength of less than 100 pounds. The guide tubes 12 are typically made from an extruded polymer, such as Nylon, although any suitable material may be used, including polyester, Teflon, PEEK, polyvinylidene fluoride, or any combination thereof. Several examples of guide tubes 12 are set forth herein:

### EXAMPLES

1. 4×6 Nylon Tubing

| | | |
|---|---|---|
| Inside Diameter | 4 | mm |
| Outside Diameter | 6 | mm |
| Pull String, A&E | 210 | T |
| Plenum Cable | 3 | mm |
| Pull Length | 60 | ft |

| | |
|---|---|
| a. Straight | 0.5 to 0.7 lbs |
| b. Two 90 deg bends | 0.7 to 0.9 lbs |
| c. Four 90 deg bends | 1.2 to 1.4 lbs |

Note:
bends had a 8″ radius

2. 4×6 Nylon Tubing

| | | |
|---|---|---|
| Inside Diameter | 4 | mm |
| Outside Diameter | 6 | mm |
| Pull String, A&E | 300 | T |
| Plenum Cable | 3 | mm |
| Pull Length | 300 | ft |

| | |
|---|---|
| a. Straight | 1.6 to 2.0 lbs |
| b. Two 90 deg bends | 2.4 to 2.9 lbs |
| c. Four 90 deg bends | 3.4 to 4.0 lbs |

Note:
bends had a 12″ radius

3. 3.3×5 Nylon Tubing

| | | |
|---|---|---|
| Inside Diameter | 3.3 | mm |
| Outside Diameter | 5 | mm |
| Pull String, A&E | 210 | T |
| Plenum Cable | 3 | mm |
| Pull Length | 80 | ft |

| | |
|---|---|
| a. Straight | 3.1 to 3.9 lbs |
| b. Two 90 deg bends | 3.7 to 4.1 lbs |
| c. Four 90 deg bends | 6.5 to 7.5 lbs |

Note:
bends had a 12″ radius

4. 3.3×5 Nylon Tubing

| | | |
|---|---|---|
| Inside Diameter | 3.3 | mm |
| Outside Diameter | 5 | mm |
| Pull String, A&E | 210 | T |
| Plenum Cable | 3 | mm |
| Pull Length | 150 | ft |

| | |
|---|---|
| a. Straight | 7.5 to 8.5 lbs |

Note:
due to confimed space this was not a entirely straight run

The textile sleeve 14 is used to protect the bundle of guide tubes 12 from abrasion, friction, and pulling force. In a preferred embodiment, the textile sleeve 14 is a woven article, made from low friction, synthetic fibers such as polyester, nylon, Teflon, polyaramid, PEEK (polyether ether ketone), or polyvinylidene fluoride. The textile sleeve 14 extends at least the same length as the guide tubes 12. The textile sleeve 14 may be woven or formed around the guide tubes 12 in the manufacturing process, or the guide tubes 12 may be inserted into the textile sleeve 14 after the manufacture thereof.

In one preferred embodiment, the textile sleeve 14 is woven around the bundle of guide tubes 12 during the manufacturing process, but it is also contemplated that the guide tubes 12 may be inserted into the textile sleeve 14 in a separate step after the manufacture thereof. Optionally, the textile sleeve 14 may be fire resistant, particularly when the assembly is being used within a building or other structure. The textile sleeve 14 may be made fire resistant by choosing fire resistant materials, or a fire resistant coating may be applied, as discussed below. Alternatively, the textile sleeve 14 may be made from reinforced composite materials, such as glass fiber reinforced epoxy or polyester composites, resin impregnated woven textile composites, or organic/inorganic hybrid composites.

The fabric material preferably is soft and pliable, allowing the textile sleeve 14 to be pulled through the conduit without snagging or generating too much heat. To this end the fabric in one embodiment is 100% plain woven nylon yarns having a 520 denier monofilament in both the warp and fill direction, woven with a pick and end count of 38.5 which, when finished, has a 40×40 pick and end count. The fabric preferably has a weight of about 6.0 oz. yd. It is understood that the monofilament denier can vary from 200-1000 denier and the pick and end could well be altered as desired. As stated above, the preferred yarn is 520 denier nylon 6 monofilament but another yarn, such as a 520 denier polyester, can be used so long as it has the desired characteristics. Other suitable fabrics may be used, although high tenacity fibers and yarns are preferred materials to construct the textile sleeve 14. In one particularly preferred embodiment, the textile sleeve 14 is a woven fabric made from polyester yarns in the warp direction, and nylon yarns in the fill direction.

The sleeve may be manufactured in a variety of ways. In one embodiment, two or more fabric strips may be stacked, one on top of the other, and sewn or otherwise attached down both longitudinal sides to form a sleeve and a channel therein. Alternatively, a single strip of fabric may be folded longitudinally, approximately in half, and attached along the free edge. The free edges of these embodiments may be attached by sewing, ultrasonic sealing, adhesive sealing, knitting, braiding, or any other suitable method may be used. In yet another embodiment, the yarns may be simply woven, knitted, or otherwise formed into a seamless tube. A flat strip of fabric may be wrapped in a spiral configuration around the bundle of guide tubes 12. Other configurations for the textile sleeve 14 are contemplated herein.

The pull cords 18 used within the guide tubes 12, in a preferred embodiment, have a breaking strength of 50 pounds or less, to prevent the cable from being damaged from exposure to excessive tension during the installation process. In one embodiment, the pull cords 18 are manufactured with minimum surface area, such as from a twisted yarn, braided or round monofilament, in order to reduce friction during installation of the cable.

In another embodiment of the present invention, the textile sleeve 14 and the guide tubes 12 may be made from fire resistant materials, particularly for use in buildings and other structures. Building codes require certain levels of fire resistance and limit levels of smoke generation for structural components, so any flexible innerduct used for such purposes would be required to meet such codes. A fire resistant flexible innerduct partitioning device may be installed within buildings, and particularly within HVAC systems, vertical and horizontal open shafts or utility spaces, such as elevator shafts, electrical cable trays, EMT duct systems, etc. Most building installations do not require extensive lengths of cable or innerduct, and are usually pulled through less than 1000 feet. For installations of these short lengths of cable and innerducts, lubricants are generally not required. Further, it should be understood that the innerduct guide tube assembly may be used for such applications without being installed within a pipe or duct system.

In order to provide a fire resistant textile sleeve 14, the fabric described herein may be manufactured in one embodiment using fiberglass yarns. In one preferred embodiment, the glass yarns are in the range of 1800 yards/lb to 22,500 yards/lb, and the fibers are woven into a plain weave structure. The fiberglass yarns may be coated with PVC or some other acceptable material, including by way of example silicone, acrylics, polyethylene or other olefins. The fiberglass fabric can be coated with binder, or the individual yarns may be coated prior to fabric formation. The coating may be used to provide protection to the brittle glass yarns, to add stability to the fabric, or to provide the necessary rigidity to the fabric to allow the chambers to be biased toward an open configuration. Alternatively, a multi-component yarn may be used, which has a glass core, wrapped with melamine, then wrapped with a fire resistant polyester. This alternative multi-component yarn is considered to be a core-sheath type of yarn.

In another alternate embodiment, flame resistance may be imparted to the flexible innerduct structure by using other types of materials, including aramid fibers, melamine fibers, polyvinylidene fluoride (PVDF) fibers, or Alumina-Boria-Silica (ceramic) fibers.

Yet another method for imparting flame resistance to a flexible innerduct structure includes extruding yarn with a flame-retardant additive in the base polymer, such as polyester and nylon. This same method may be used to extrude the guide tubes 12, as well. Potential additives that may be used in such an extrusion process include intumescent compounds including alumina trihydrate, magnesium oxides, magnesium borates; other boron containing compounds such as zinc borate, ammonium phosphate; residue forming carbonaceous materials including pentaerythritol, alkyd resins, or polyols; nitrogen containing compounds including melamine, and dicyandiamide, antimony oxides; halogenated organics, such as decabromodiphenyl oxide; phosphorous containing compounds such as ammonium phosphates; other phosphate salts, and organic phosphates. These flame retardants are commonly used in combination with each other such as a halogenated hydrocarbon system with antimony oxide (such as Dechlorane Plus®).

Still another method of imparting flame retardant to a flexible innerduct structure is to treat the textile sleeve 14 and/or the guide tubes 12 with a flame retardant coating. Possible flame-retardants that may be used for such a coating include the list set forth above, with or without a binder system.

One particularly effective method of producing a fire resistant textile sleeve 14 or guide tube structure is to extrude Nylon 6 resin with a melamine cyanurate additive at approximately 6% to 8% by weight. Thus, the structure of this embodiment of the textile sleeve 14 may include a fabric having 520 denier Nylon 6 with a 6.75% melamine cyanurate in both the warp and fill directions, in a plain weave of preferably a 30×35 construction. It should be understood that the additive may comprise from 2% to 12% by weight of the extruded yarn or guide tube, preferably 4% to 10%, and more preferably 6% to 8%.

It should be understood that pull tapes also may be rendered fire resistant by using any of the methods or materials set forth above.

In use, the textile sleeve 14 carrying the guide tubes 12 may be attached at one end to a pull cord 18 or tape that extends through the length of a conduit, as shown in FIG. 3. A pulling force is exerted on the pull cord 18 at a remote end, causing the textile sleeve 14 and guide tubes 12 to be drawn through the conduit. The textile sleeve 14 bears most of the force of the pulling action, and the only force exerted directly on the guide tubes 12 is that of friction between the sleeve and the tubes. Because the textile sleeve 14 should be capable of withstanding such a pulling force, it should have sufficient tensile strength in the longitudinal direction to allow successful installation without mechanical failure of the textile sleeve 14. The breaking strength of the textile sleeve 14 in the longitudinal direction is preferably greater than 600 pounds. This arrangement allows the guide tubes 12, and ultimately a plurality of cables, to be inserted into a rigid or semi-rigid conduit with greater speed, less friction, and less likelihood of damage to the cable itself. Further, because the textile sleeve 14 bears the major portion of the force required to pull the assembly through the conduit, the cable (particularly fiber optic cable) need not be manufactured with extensive strength members incorporated therewith. The textile sleeve 14 also provides abrasion and cutting resistance.

While preferred embodiments have been disclosed and described in considerable detail, the spirit and scope of the appended claims should not be limited to the description of the preferred versions contained herein. For instance, although the innerduct guide tube assembly described herein has been more specifically described with respect to fiber optic cables, it is to be understood that any type of cable may be used within the assembly. Alternative features or components serving the same, equivalent or similar purpose may replace all features disclosed in this specification, unless expressly stated otherwise. Thus, unless expressly stated otherwise, each feature disclosed is one example only of a generic series of equivalent or similar features.

1. An innerduct guide tube assembly comprising:
at least one guide tube; and
a textile sleeve disposed about said guide tube so that said guide tube is in slidable relation with said textile sleeve.

2. The innerduct guide tube assembly set forth in claim 1, wherein said textile sleeve is a woven article.

3. The innerduct guide tube assembly set forth in claim 2, wherein said textile sleeve is made from material selected from the group consisting of glass, aramid, PVDF, melamine, ceramic, polyvinyl chloride, polyphenylene sulfide, polyester, nylon, Teflon, PEEK and polyvinylidene fluoride, mineral fibers, basalt, carbon or any combination thereof.

4. The innerduct guide tube assembly set forth in claim 1, wherein said textile sleeve is made from a monofilament fiber.

5. The innerduct guide tube assembly set forth in claim 1, wherein said textile sleeve exhibits a breaking strength in the longitudinal direction of greater than 600 pounds.

6. The innerduct guide tube assembly set forth in claim 1, wherein said textile sleeve is made of fire resistant materials, chosen from the group consisting of polytetrafluoroethylene, polyvinylidene fluoride, or PEEK.

7. The innerduct guide tube assembly set forth in claim 1, wherein said textile sleeve is at least the same length as said guide tube.

8. The innerduct guide tube assembly set forth in claim 1, wherein a plurality of guide tubes is disposed within a singe textile sleeve.

9. The innerduct guide tube assembly set forth in claim 1, wherein said textile sleeve is a composite material.

10. The innerduct guide tube assembly set forth in claim 1, wherein said guide tube is manufactured from a material selected from the group consisting of polyester, nylon, Teflon, PEEK and polyvinylidene fluoride, or any combination thereof.

11. The innerduct guide tube assembly set forth in claim 1, wherein said textile sleeve is coated with material selected from the group consisting of: polyvinyl chloride, silicone, acrylics, polyethylene or other olefins, and any combination thereof.

12. The innerduct guide tube assembly set forth in claim 1, wherein said guide tube is coated with material selected from the group consisting of: polyvinyl chloride, silicone, acrylics, polyethylene or other olefins, and any combination thereof.

13. The innerduct guide tube assembly set forth in claim 1, wherein said textile sleeve is manufactured from synthetic material containing a flame retardant additive.

14. The innerduct guide tube assembly set forth in claim 13, wherein said flame retardant additive is selected from the group consisting of: alumina trihydrate, magnesium oxides, magnesium borates, zinc borate, ammonium phosphate, pentaerythritol, alkyd resins, polyols, melamine, melamine cyanurate, dicyandiamide, antimony oxides, halogenated organics, decabromodiphenyl oxide, ammonium phosphates, and organic phosphates and any combination thereof.

15. The innerduct guide tube assembly set forth in claim 1, wherein said guide tube is manufactured from synthetic material containing a flame retardant additive.

16. The innerduct guide tube assembly set forth in claim 15, wherein said flame retardant additive is selected from the group consisting of: alumina trihydrate, magnesium oxides, magnesium borates, zinc borate, ammonium phosphate, pentaerythritol, alkyd resins, polyols, melamine, melamine cyanurate, dicyandiamide, antimony oxides, halogenated organics, decabromodiphenyl oxide, ammonium phosphates, and organic phosphates and any combination thereof.

17. The innerduct guide tube assembly set forth in claim 1, wherein said textile sleeve is made from fabric comprising multi-component fibers.

18. The innerduct guide tube assembly set forth in claim 17, wherein said multi-component fibers are core-sheath types of fibers.

19. The innerduct guide tube assembly set forth in claim 18, wherein said multi-component fibers include a glass core wrapped with a layer of melamine.

25. The innerduct guide tube assembly set forth in claim 19, wherein said multi-component fibers further include a layer of fire resistant polyester.

26. The innerduct guide tube assembly set forth in claim 1, wherein said textile sleeve is a woven fabric having polyester yarns in the warp direction and nylon yarns in the fill direction.

27. The innerduct guide tube assembly set forth in claim 1, wherein said guide tube contains means for installing a cable therein.

28. The innerduct guide tube assembly set forth in claim 27, wherein said means for installing a cable comprises a structure chosen from the group consisting of pull tape, pull cord, twisted monofilament yarn, braided yarn, monofilament yarn having a generally round cross-section, or any combination thereof.

30. A process for inserting an innerduct guide tube assembly into a conduit, said process comprising the steps of:
providing at least one guide tube;
providing a textile sleeve around said guide tube, so that said guide tube is disposed within said textile sleeve in slidable relation; and
imparting a force on said textile sleeve for insertion into a conduit, wherein said textile sleeve carries said guide tube into and through said conduit therewith.

31. The process for inserting an innerduct guide tube assembly into a conduit as set forth in claim 30, wherein said step of imparting a force on said textile sleeve includes pulling said textile sleeve through said conduit.

32. The process for inserting an innerduct guide tube assembly into a conduit as set forth in claim 30, wherein said step of imparting a force on said textile sleeve includes blowing said textile sleeve through said conduit.

33. The process for inserting an innerduct guide tube assembly into a conduit as set forth in claim 30, wherein said textile sleeve is made from material selected from the group consisting of glass, aramid, PVDF, melamine, ceramic, polyvinyl chloride, polyphenylene sulfide, polyester, nylon, Teflon, PEEK and polyvinylidene fluoride, mineral fibers, basalt, carbon or any combination thereof.

34. The process for inserting an innerduct guide tube assembly into a conduit as set forth in claim, wherein said textile sleeve is made from monofilament fiber.

35. The process for inserting an innerduct guide tube assembly into a conduit as set forth in claim 30, wherein said textile sleeve is a woven article.

36. The process for inserting an innerduct guide tube assembly into a conduit as set forth in claim 30, wherein said textile sleeve is at least the same length as said guide tube.

37. The process for inserting an innerduct guide tube assembly into a conduit as set forth in claim 30, wherein said textile sleeve exhibits a breaking strength of greater than 600 pounds in the longitudinal direction.

38. The process for inserting an innerduct guide tube assembly into a conduit as set forth in claim 30, wherein a plurality of guide tubes are disposed within said textile sleeve.
